(19) United States
(12) Patent Application Publication
(10) Pub. No.: US 2011/0082752 A1
(43) Pub. Date: Apr. 7, 2011

(54) METHOD AND SYSTEM FOR LOCATION-AWARE USER SPECIFIC ADVERTISEMENTS

(75) Inventors: Parijat Dube, Hawthorne, NY (US); Rahul Jain, Los Angeles, CA (US); Sambit Sahu, Hawthorne, NY (US)

(73) Assignee: INTERNATIONAL BUSINESS MACHINES CORPORATION, ARMONK, NY (US)

(21) Appl. No.: 12/572,418

(22) Filed: Oct. 2, 2009

(51) Int. Cl. G06Q 30/00; G01C 21/32

(52) U.S. Cl. 705/14.67; 705/14.58; 701/209

(57) ABSTRACT

A user interface is configured to permit interaction between a user and a location-aware device. A user profile is stored in memory including profile features describing at least one of historic user actions and expected probabilities of user actions. An information server interacts with the user through the user interface, the server being configured to correlate advertisements based on a current location of the user in accordance with the location-aware device and information included in the user profile.

### BACKGROUND

1. Technical Field

The present invention relates to global positioning systems and more particularly to systems and methods for generating navigation routes based upon user-based financial and other information.

2. Description of the Related Art

Advertisements are most effective when targeted to a specific demographic interested in the item or service being advertised. Push ads are typically unsolicited, without regard to the location or user preference and may not be as effective. Some push ads may be based on a location of a user (e.g., location aware banner ads).

Pull ads may tend to be more effective, such as mobile-web search related ads, where a user's information or past choices may be used to clue the advertiser on the user's interests or needs. Pull ads may also employ location information, such as a pizza restaurant search, which may employ a present location of the user in order to provide for local delivery. Target ads on mobile devices may be solely based on a user's current location. Other display ads on mobile devices may be based on search queries. These existing techniques typically use location as an independent piece of information and are not tied to user preferences.

### SUMMARY

A user interface is configured to permit interaction between a user and a location-aware device. A user profile is stored in memory including profile features describing at least one of historic user actions and expected probabilities of user actions. An information server interacts with the user through the user interface, the server being configured to correlate advertisements based on a current location of the user in accordance with the location-aware device and information included in the user profile.

A system includes a user interface configured to permit interaction between a user and a location-aware device. A user profile is stored in memory and includes profile features describing at least one of historic user actions and expected probabilities of user actions. An information server interacts with the user through the user interface, the server being configured to leverage a user's travel plan and intent to customize a navigation route, which is based on user behavior and preferences as provided in the user profile.

A method for navigation routing includes providing a user profile in memory to store at least one of historic actions and expected behaviors of a user given commercial establishments on a given path; generating a travel route in a navigation system based upon at least one of the historic actions and the expected behaviors of the user by determining a match with the commercial entities on a plurality of paths; and offering the travel route to the user.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing an individual profile based navigation system in accordance with one embodiment;

FIG. 2 is a block/flow diagram showing a cluster profile based navigation system in accordance with one embodiment;

FIG. 3 is a block/flow diagram illustratively showing user actions and devices employed to update a user profile in accordance with one embodiment;

FIG. 4 is a block/flow diagram showing user action selections employed to update a user profile in accordance with one embodiment;

FIG. 5 is a block/flow diagram showing a navigation system in accordance with the present principles; and

FIG. 6 is block/flow diagram showing a navigation routing system/method in accordance with one embodiment.

### DETAILED DESCRIPTION OF PREFERRED EMBODIMENTS

The present principles provide systems and methods for targeted advertisements on location-aware mobile devices, such as an iPhone® or other devices, based on a location as well as user-specific information, e.g., a user profile, information deduced from history, etc. Ads appear on a graphical navigation application as the user navigates. One system displays ads specific to a user's current location and route. Another system may also change a user's route based on his shopping history as well as special discount sale options available. The system also infers effectiveness of the displayed ads by deducing whether the user stopped to shop as a result of the ads, both from a user purchase history available from advertisers as well as from the time spent by a user at a particular location. Other factors may also be employed.

In accordance with particularly useful embodiments, automated placement of relevant ads to users is based on the user profiles and travel routes while driving or otherwise navigating. A computation of a best route for the user may match the user's buying preferences to bias the route choices. By coupling mobile advertising with route computation, ad effectiveness can be maximized, and the dynamic computation of routes can maximize a user preference matching. A closed-loop system for measuring ad effectiveness is also provided.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

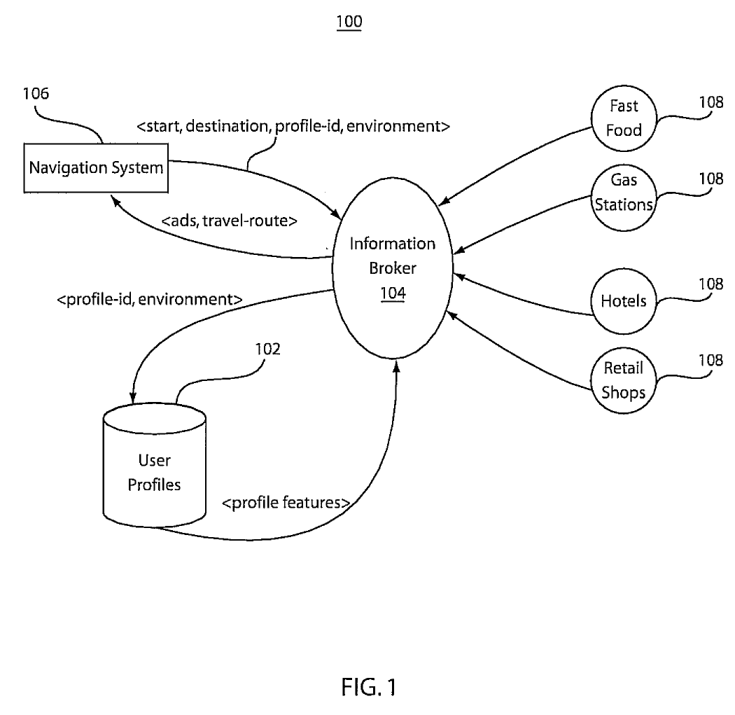

Referring now to the drawings in which like numerals represent the same or similar elements and initially to FIG. 1, an individual profile based system 100 is depicted. A user profile 102 includes profile features related to an individual user. The features of the user profile will be described in greater detail below. An information broker 104 may include a server or other network computing device that correlates user actions with a navigation system 106 and advertising entities 108. The advertising entities 108 may include any number of businesses or entities placing ads with the information broker 104. These entities 108 may include, e.g., fast food establishments, gas stations, hotels, retail shops, etc.

The information broker 104 places ads or information on the navigation system of a user based upon the user profile 102 and the entity 108 running the ad. The entity may pay for an ad or may simply be registered with a navigation service as, e.g., a point of interest or the like. The user profile 102 may be maintained at the broker 104, on the user's navigation system 106 or at another location.

The navigation system 106 starts by sending a profile-id and environment information (location of the user) to the broker 104. The broker 104 uses the profile-id to search for the user profile 102. The user profile 102 provides profile features to the broker 104 to make determinations regarding what ads to display on the navigation system or which travel route to suggest to the user based on the user profile features.

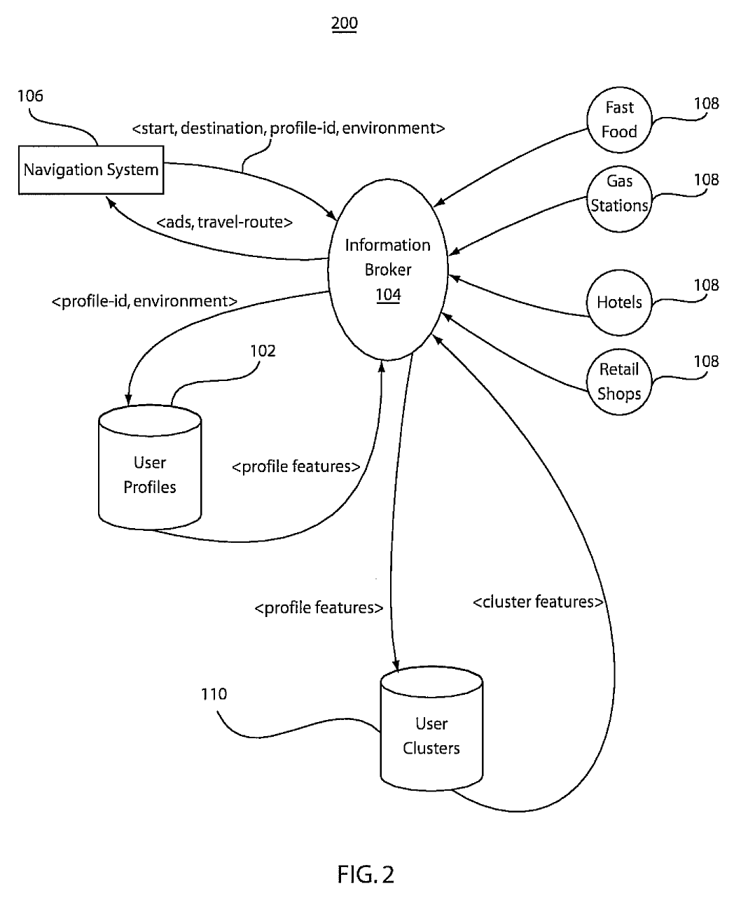

Referring to FIG. 2, another embodiment is shown where user clusters 202 are employed in a cluster profile based system 200. The user profiles 102 include profile features related to individual users. The information broker 104 places ads or information on the navigation system 106 of a user based upon the user profile 102 and the entity 108 running the ad. The entity 108 may pay for an ad or may simply be registered with a navigation service as e.g., a point of interest or the like. The user profile 102 may be maintained at the broker 104, on the user's navigation system 106 or at another location.

The users are clustered based on their feature set (e.g., preferred shopping locations, price points, sales, demographics, shopping habits, preferred stores or chains, etc.) with the clusters maintained at the server 104. A user request carries profile features. The ad server identifies the cluster for the user based on cluster profile 110 and user profile 102 in the request. Different clustering algorithms can be employed for clustering the users based on their feature set.

The navigation system 106 starts by sending a profile-id, a destination and environment information (location of the user) to the broker 104. The broker 106 uses the profile-id to search for the user profile 102. The user profile 102 provides profile features to the broker 104 to make determinations regarding what ads to display on the navigation system 106 or which travel route to suggest to the user based on the user profile features. The broker 104 may employ common data or profile features to cluster users in accordance with cluster features in user clusters 110. The cluster features may be a changing class (e.g., based on an entered destination in the navigation system 106) or an unchanging class (e.g., gender of the user). Clusters 110 may be employed to reduce work load by updating a class or cluster together. Clusters 110 also provide demographic groupings to help target advertising.

Referring to FIGS. 1 and 2, systems 100 and 200 may be built using current graphical navigation systems that give turn-by-turn navigation instructions. The present system 100, 200 displays ads based on a user's current location and his location or planned route. However, the ads can be more effective if they are targeted based on a closed loop feedback system to gather environmental data about user preferences, user actions (sales, requests for information, etc.). The system measures the effectiveness of the previous ads, and takes that into account when placing the ads. The effectiveness can be measured in several ways: (i) probability of a click (user paid attention to ad by clicking to see more information), (ii) expected time spent/day (user stopped to shop but did not buy), (iii) expected purchase/day (user stopped to shop and made a purchase).

Examples of information that can be collected to establish the effectiveness may include: Measure (i) can be computed easily from history. Measure (ii) can be obtained by a method or algorithm. Measure (iii) can be obtained from the purchase history of the user obtained by the advertiser. Other measures are also contemplated.

The configurations as described in FIGS. 1 and 2 may be employed to perform the following tasks. In one embodiment as depicted in FIG. 2, ads that match the user profile 102 are determined. For each ad, a user may be identified for matching by any number of criteria. In the present example, three features are employed to determine a match: a probability of a click (a mouse click, touch screen touch, etc.), an expected time spent on the ad (e.g., time spent on the ad is the time spent at the facility corresponding to the ad), and expected purchase on the ad. This information may be computed based upon actual data (historic data of purchases and ad viewing of the user or from projected information, e.g., since the user purchased product A, he is likely to purchase product B). Users may be clustered based on their feature set with the user clusters 110 maintained at the server or broker 104. The user cluster 110 may be identified based on any number of criteria such as user location preferences, history, etc. A user request for a navigation route carries profile features to the broker 104. The broker identifies the cluster 110 for the user based on a cluster profile and the user profile 102. Different clustering algorithms may be employed for clustering the users based on their feature set.

Ads are identified that match the user profile and may be sent to and displayed on the user's navigation device 106. While a navigation device 106 is described, other location-aware devices may be employed that display ads in accordance with location and the user profile. Ads from businesses or entities are matched to cluster features and displayed on the user's device. It should be understood that the clusters 110 may not be employed, and instead the ads may be matched to individual profiles 102 directly.

In another embodiment, route identification may be biased or selected based upon user profile information. A route may not be the shortest path from a source to a destination. Route information may include relevant businesses or entities and their ads. For example, special sales or offers like coupons for businesses disposed along a path may be used to influence the navigation route. A coupon code or e-coupon may be offered to a user to get the user to stop and use the coupon.

Depending on the user preferences, alternate routes may be presented to the user. This maximizes a match between a user's current preferences and some location or point of interest on the route path. Bounds or limits may be enforced or selected as well, e.g., a fast food establishment should not be more than 5 miles off the shortest path. In this way, a user running errands or passing through an area may be alerted to and guided to an establishment that satisfies one or more of their preferences as learned from their profile 102 or their cluster features 110.

In another illustrative embodiment, a multi-criteria optimization may be performed by system 100 or 200. This may be achieved by maximizing a preference match with a bound on travel time, with a bound on total expenditure during travel, etc. This may be performed by inputting a time bound or a money bound into the system (100, 200). If the route selected for a navigation path fits within the time bound or if an average spending amount fits within a budget for spending destinations along the path, then the path can be selected or even customized based upon the bound or budget. This example may even account for tolls and fuel costs. In one embodiment, a calendar may be employed in a user profile 102 so that appointments or destinations may be accessible by the system (100, 200) to be able to compute routes in accordance with time budgets.

The optimization may include a one time static optimization at the beginning of travel based on one or more of a user inputted bound, user profile features or cluster features. Dynamic optimization based on learning user behavior and buying patterns along a particular route may be employed to decrement the time or money budget.

In another embodiment, ads and routes may be presented to a user in accordance with their profile. In this case, a broker 104 pushes route information to the user along with ads. A one time static ad may be provided to the user or ads may dynamically pop up as the travel route progresses.

The user may have a filter option to filter out certain types of ads or all ads. Ads may be annotated with meta data information. The user terminal (e.g., a navigation device, cell phone, etc.) may maintain a preference list for the user in terms of metadata. The metadata may indicate one or more of a type of ad, the advertiser, the subject matter of the ad, etc. Annotation of the ad preferably follows a same schema as the metadata used by the user preferences. In this way, a match is easily made as to whether the ad should be filtered or permitted for display. The incoming ad stream can be filtered at the user terminal based on the user preferences in the profile 102. The filtered ads are presented to the user and may include audio as well and video or image content. The user's interface (e.g., navigation system 106) may be employed for feedback on the ad or filtered ad (e.g., provide touch screen buttons or other input to ads on the screen/display).

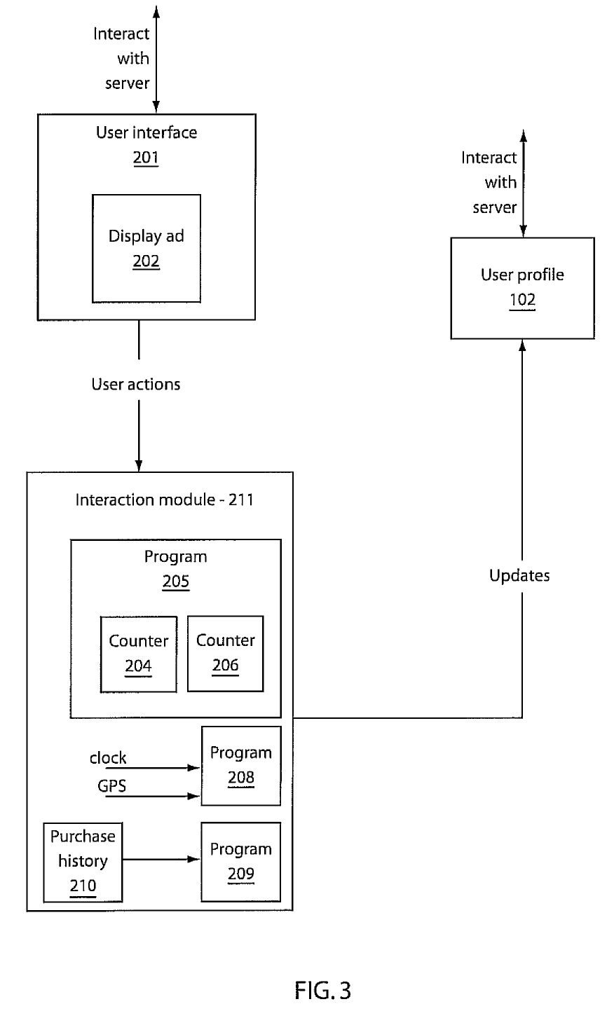

Referring to FIG. 3, different actions taken by a user after a display ad 202 is presented may be used to update the user profile 102 (FIGS. 1 and 2). A user interface 201 may be employed as part of a closed loop feedback system as shown in FIG. 3. Feedback from/about user actions may be sent directly to the user profile (for a networked server) or to the interface 201. This can act as a measure for the effectiveness of ads, be used to update user profile features, etc. To update features in the user profile 102, different metrics may be collected by an interaction module 211. For example, a method or program 205 includes at least one counter (e.g., counter 204 or 206). A counter 204 may be employed to determine a number of clicks on an ad by the user, a counter 206 may be employed for a number of times the ad 202 is displayed to the user, etc. Other counters or mechanisms may also be employed. The click counts in context can be employed to measure a click probability. Click probability may be computed as a probability that a user will click on a particular ad or a particular type of ad. With a high probability computation, the user profile 102 will be updated to reflect this characteristic.

A method or program 208 to estimate the time spent on an ad or at a location may be provided. The time spent is an estimate of the amount of time spent at a physical facility (Macy's™ store for a Macy's™ ad) or viewing an ad, etc. The time spent may be computed in a number of ways. For example, the time spent may be calculated by tracking global positioning system (GPS) information from a mobile device or navigation device. Clock (clock) and GPS information may be inputs to program 208. A telephone position or a car in the parking lot of the store may be employed as an indicator of time spent. The more time spent at an entity the more relative credit (effectiveness) is attributed to the mobile ad. If time spent at a retail store or other entity reaches a threshold, the user profile may be updated accordingly. Alternately, a record of all time spent on a given day, week, month, etc., may be stored and employed to update the user profile 102.

A method or program 209 to estimate a purchase on an ad by the user in dollar amount may be employed. A purchase history 210 of the user (if available) may be employed to associate spending with the ad 202. A usage record of discount coupons which were displayed to the user and were actually used would be one way to correlate ads with spending. Other techniques may also be employed. The more purchases, the more the relative credit is attributed to the ads effectiveness. The user's profile may be updated accordingly.

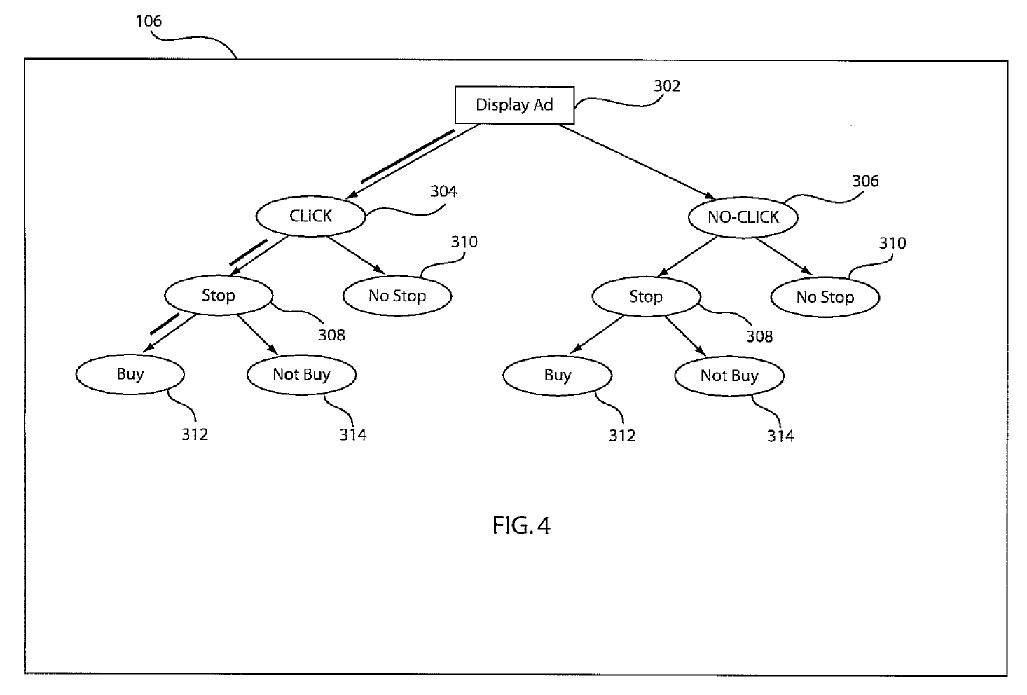

Referring to FIG. 4, an ad's effectiveness may also be measured in accordance with a direct purchase using the ad. A sample set of user actions is displayed in FIG. 4. Based on the measurements, the user features are updated for a given ad. A display ad 302 may be displayed on a user's navigation system 106 when a user is in the vicinity of a particular store based on location-aware technology. The user actions may be recorded in the user's profile 102. Whether the user clicked on the ad for more information in block 304 or not in block 306 is recorded. If the user clicked on the ad, did the user stop 308 (to purchase or find out more) or not 310? If the user stopped, did the user buy 312 or not 314? If the user did not click on the ad, did the user stop 308 or not 310? If the user stopped, did the user buy 312 or not 314? The ad may include interactive buttons or areas which permit interactions for more detailed information. The user actions may be employed to update the user profile 102.

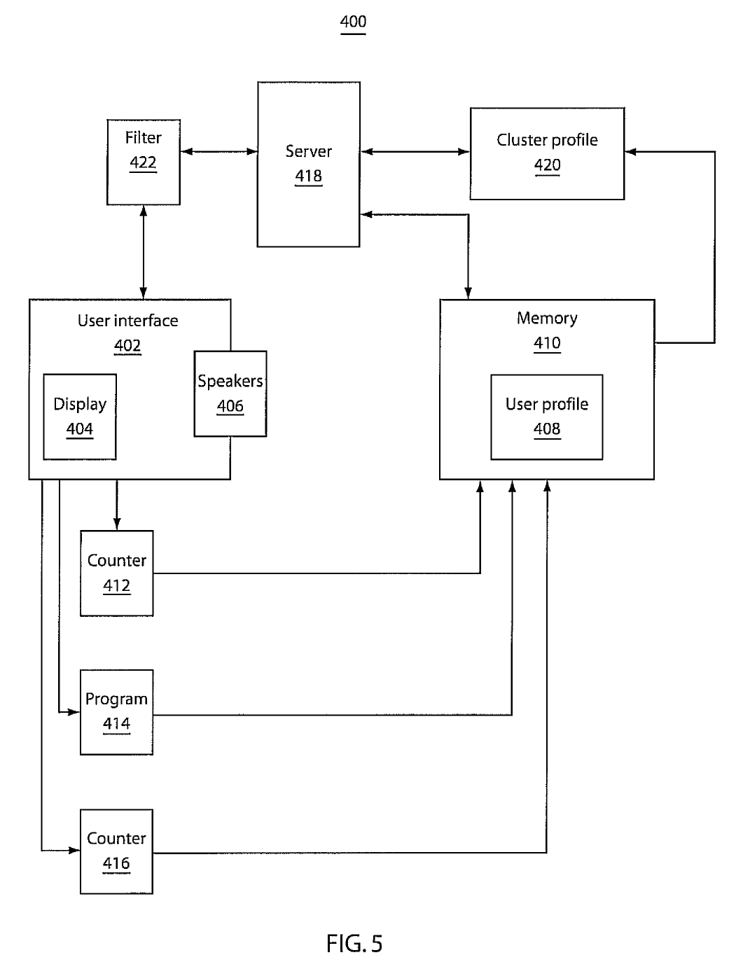

Referring to FIG. 5, a system 400 is depicted for navigating a route in accordance with a user profile. A user interface 402 is configured to permit interaction between a user and a location-aware device. The location-aware device may be integrated with the user interface 402. The interface 402 may include a display screen 404 and include speakers 406 for visually and audibly rendering maps, information, ads, etc. The interface 402 may include interaction tools such as point and click tools, touch screen capability, speech recognition (using a microphone) or the like. The interface 402 may exist on a telephone, a navigation device, a personal digital assistant, or other location-aware device. The interface 402 is preferably co-located with the user. Other components are disposed remotely from the user although may be co-located with the user as well.

A user profile 408 is stored in memory 410 including profile features describing at least one of historic user actions and expected probabilities of user actions. In one embodiment, the expected probabilities include one or more of: a probability of requesting additional information regarding the advertisement, an expected time spent at a location of a commercial establishment, and an expected purchase decision based on a given advertisement. These probabilities and expected parameters may be updated by taking measurements. Measurements may be taken using, e.g., at least one counter 412 to determine a frequency of interaction with an advertisement to determine a probability of requesting additional information on a given advertisement; a program 414 configured to determine an expected time spent at a location of a commercial establishment; and a program 416 configured to determine an expected purchase decision based on a given advertisement. Other measurements and determinations may be made instead of or in addition to these.

An information server 418 interacts with the user through the user interface 402. The server 418 is configured to leverage a user's travel plan and intent to customize a navigation route, which is based on user behavior and preferences as provided in the user profile. The server 418 may also simply push ads to the user interface 402 in accordance with the user profile 408.

The system 400 can route the user to commercial establishments in accordance with a budget. The budget may be input by the user, be a default or be set by the systems 400. The budget may include at least one of a time budget and a financial budget. A cluster profile 420 may be configured to store a plurality of user identities satisfying a common criterion. For example, an interest in footwear, discount stores, a food chain, etc. An advertisement filter 422 may be provided which can be activated and customized by the user to block selected advertisements from the user interface 402 sent by the server 418.

The present embodiments improve ad efficacy by leveraging user's travel plan and intent where a suggested customization of route is provided based on the user's interest and behavior profile instead of sticking to known paths or shortest paths. Customized travel routes are provided to users based on the user preferences to improve satisfaction. In addition, the present embodiments improve ad companies' potential revenue by correlating travel intent information of users along with their social behavior using provided information and derived information for ad placements. Ads may include coupons, sales promotions, gas prices, etc. or could be presented using different modalities, visually as an add-on over maps in a GPS system or through live/recorded audio or combination of both. A closed-loop system is employed to update user profiles and ad effectiveness based on observed/inferred behavior of customers in response to ads.

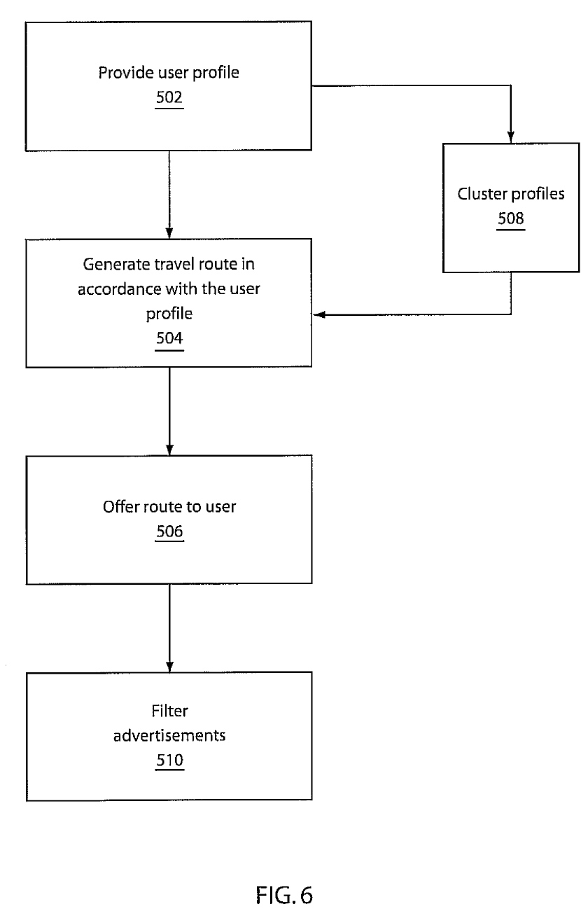

Referring to FIG. 6, a system/method for navigation routing is illustratively described in accordance with one embodiment. In block 502, a user profile is provided in memory to store at least one of historic actions and expected behaviors of a user given commercial establishments on a given path. The user profile may include one or more of a probability of requesting additional information regarding the advertisement, an expected time spent at a location of a commercial establishment, and an expected purchase decision based on a given advertisement. The user profile may be updated with this and other information. Other features may be employed in the user profile to match features.

In block 504, a travel route is generated in a navigation system based upon at least one of the historic actions and the expected behaviors of the user by determining a match with the commercial entities on a plurality of paths. This may include routing the user to commercial establishments in accordance with a budget wherein the budget includes at least one of a time budget and a financial budget.

In block 506, the travel route is offered to the user. The user may or may not select the travel route. In block 508, users may be clustered in a cluster profile configured to store a plurality of user identities satisfying a common criterion. In block 510, advertisements may be filtered to block selected advertisements from a user interface.

Having described preferred embodiments of a method and system for location-aware user specific advertisements (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A system, comprising:
a user profile stored in memory including profile features describing at least one of historic user actions and expected probabilities of user actions; and
an information server interacting with a user through a user interface configured to permit interaction between a user and a location-aware device, the server being configured to correlate advertisements based on a current location of the user in accordance with the location-aware device and information included in the user profile.

2. The system as recited in claim 1, wherein the location-aware device includes a navigation system and the user profile includes features employed by the server to change a route in accordance with the features in the user profile.

3. The system as recited in claim 2, wherein the navigation system routes the user to commercial establishments in accordance with the user profile features.

4. The system as recited in claim 2, wherein the navigation system routes the user to commercial establishments in accordance with a budget.

5. The system as recited in claim 4, wherein the budget includes at least one of a time budget and a financial budget.

6. The system as recited in claim 1, wherein the features include one or more of: a probability of requesting additional information regarding the advertisement, an expected time spent at a location of a commercial establishment, and an expected purchase decision based on a given advertisement.

7. The system as recited in claim 1, further comprising at least one counter to determine a frequency of interaction with an advertisement to determine a probability of requesting additional information on a given advertisement.

8. The system as recited in claim 1, further comprising a program configured to determine an expected time spent at a location of a commercial establishment.

9. The system as recited in claim 1, further comprising a program configured to determine an expected purchase decision based on a given advertisement.

10. The system as recited in claim 1, further comprising a cluster profile configured to store a plurality of user identities satisfying a common criterion.

11. The system as recited in claim 1, further comprising an advertisement filter configured to block selected advertisements from the user interface sent by the server.

12. A system, comprising:
a user interface configured to permit interaction between a user and a location-aware device;
a user profile stored in memory including profile features describing at least one of historic user actions and expected probabilities of user actions; and
an information server interacting with the user through the user interface, the server being configured to leverage a user's travel plan and intent to customize a navigation route, which is based on user behavior and preferences as provided in the user profile.

13. The system as recited in claim 12, wherein the location-aware device includes a navigation system, which routes the user to commercial establishments in accordance with the user profile.

14. The system as recited in claim 13, wherein the navigation system routes the user to commercial establishments in accordance with a budget.

15. The system as recited in claim 12, wherein the user profile includes one or more of a probability of requesting additional information regarding the advertisement, an expected time spent at a location of a commercial establishment, and an expected purchase decision based on a given advertisement.

16. The system as recited in claim 12, further comprising at least one counter to determine a frequency of interaction with an advertisement to determine a probability of requesting additional information on a given advertisement.

17. The system as recited in claim 12, further comprising a program configured to determine an expected time spent at a location of a commercial establishment.

18. The system as recited in claim 12, further comprising a program configured to determine an expected purchase decision based on a given advertisement.

19. The system as recited in claim 12, further comprising a cluster profile configured to store a plurality of user identities satisfying a common criterion.

20. A method for navigation routing, comprising:
providing a user profile in memory to store at least one of historic actions and expected behaviors of a user given commercial establishments on a given path;
generating a travel route in a navigation system based upon at least one of the historic actions and the expected behaviors of the user by determining a match with the commercial entities on a plurality of paths; and
offering the travel route to the user.

21. The method as recited in claim 20, wherein generating includes routing the user to commercial establishments in accordance with a budget wherein the budget includes at least one of a time budget and a financial budget.

22. The method as recited in claim 20, wherein the user profile includes one or more of: a probability of requesting additional information regarding the advertisement, an expected time spent at a location of a commercial establishment, and an expected purchase decision based on a given advertisement.

23. The method as recited in claim 20, further comprising clustering users in a cluster profile configured to store a plurality of user identities satisfying a common criterion.

24. The method as recited in claim 20, further comprising filtering advertisements to block selected advertisements from a user interface.

25. A computer readable storage medium comprising a computer readable program, wherein the computer readable program when executed on a computer causes the computer to perform the steps in accordance with claim 20.
